(19) United States
(12) Patent Application Publication
(10) Pub. No.: US 2015/0024732 A1
(43) Pub. Date: Jan. 22, 2015

(54) ELECTRONIC DEVICE AND METHOD FOR CONTROLLING THE SAME

(71) Applicant: Kabushiki Kaisha Toshiba, Tokyo (JP)

(72) Inventors: Joji Yamashita, Hachioji-shi (JP); Yu Onodera, Kumagaya-shi (JP); Fumihiko Murakami, Yokohama-shi (JP); Norikatsu Chiba, Tokyo (JP); Kazuki Kuwahara, Saitama-shi (JP)

(73) Assignee: Kabushiki Kaisha Toshiba, Tokyo (JP)

(21) Appl. No.: 14/249,195

(22) Filed: Apr. 9, 2014

Related U.S. Application Data
(60) Provisional application No. 61/857,163, filed on Jul. 22, 2013.

(51) Int. Cl. H04M 1/725; H04W 68/00; H04W 4/16

(52) U.S. Cl. CPC H04M 1/7253; H04W 4/16; H04M 1/72577; H04W 68/005
USPC 455/419; 455/556.1

(57) ABSTRACT

According to one embodiment, an electronic device including a display configured to display video, a speech reproduction module configured to reproduce speech, a reception module configured to receive a notification of an incoming call to a connected call-capable device, and a controller configured to cause the display to display receipt of the incoming call when the reception module receives the notification of the incoming call to the call-capable device.

### CROSS-REFERENCE TO RELATED APPLICATIONS

This application claims the benefit of U.S. Provisional Application No. 61/857,163, filed Jul. 22, 2013, the entire contents of which are incorporated herein by reference.

### FIELD

Embodiments described herein relate generally to an electronic device and a method for controlling the same.

### BACKGROUND

An electronic device is capable of transmitting a stream in compliance with standards such as a High-Definition Multimedia Interface (HDMI) and a Mobile High-Definition Link (MHL).

An electronic device (hereinafter referred to as a source apparatus or a control device) on the side that outputs a stream outputs a stream to an electronic device (hereinafter referred to as a sink apparatus or an image receiving device) on the side that receives a stream. When the source apparatus and the sink apparatus are connected to each other via a cable compatible with the MHL standard, the apparatuses are capable of mutually controlling operation of each other. That is, with the establishment of the MHL standard and a spread of compatible devices, data communications between a mobile information terminal device (source apparatus) such as a mobile telephone and a tablet terminal device and an image receiving device (sink apparatus) such as a television receiver are becoming generalized.

When the source apparatus receives incoming speech communication data or other incoming communication data similar thereto while the sink apparatus is reproducing a stream received from the source apparatus, however, the source apparatus may stop output of the stream (from the source apparatus).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a transmitting and receiving system according to an embodiment;

FIG. 2 is an exemplary diagram showing an example of a video receiving apparatus according to the embodiment;

FIG. 3 is an exemplary diagram showing an example of a mobile terminal according to the embodiment;

FIG. 4 is an exemplary diagram showing an example of the transmitting and receiving system according to the embodiment;

FIG. 5 is an exemplary diagram showing an example of the transmitting and receiving system according to the embodiment;

FIG. 6 is an exemplary diagram showing an example of a transmitting and receiving process according to the embodiment;

FIG. 7 is an exemplary diagram showing an example of a process for transmitting and receiving according to an embodiment;

FIG. 8 is an exemplary diagram showing an example of a displaying for video receiving apparatus according to an embodiment;

FIG. 9 is an exemplary diagram showing an example of a displaying for video receiving apparatus according to an embodiment;

FIG. 10 is an exemplary diagram showing an example of a displaying for video receiving apparatus according to an embodiment;

FIG. 11 is an exemplary diagram showing an example of the transmitting and receiving process according to the embodiment;

FIG. 12 is an exemplary diagram showing an example of the transmitting and receiving process according to the embodiment;

FIG. 13 is an exemplary diagram showing an example of the transmitting and receiving process according to the embodiment;

FIG. 14 is an exemplary diagram showing an example of a process for transmitting and receiving according to an embodiment;

FIGS. 15A and 15B are exemplary diagrams each showing an example of display of the video receiving apparatus according to the embodiment; and

FIGS. 16A, 16B, 16C and 16D are exemplary diagrams each showing an example of display of the video receiving apparatus according to the embodiment.

### DETAILED DESCRIPTION

Various embodiments will be described hereinafter with reference to the accompanying drawings.

In general, according to one embodiment, an electronic device comprising: a display configured to display video; a speech reproduction module configured to reproduce speech; a reception module configured to receive a notification of an incoming call to a connected call-capable device; and a controller configured to cause the display to display receipt of the incoming call when the reception module receives the notification of the incoming call to the call-capable device.

Embodiments will now be described hereinafter in detail with reference to the accompanying drawings.

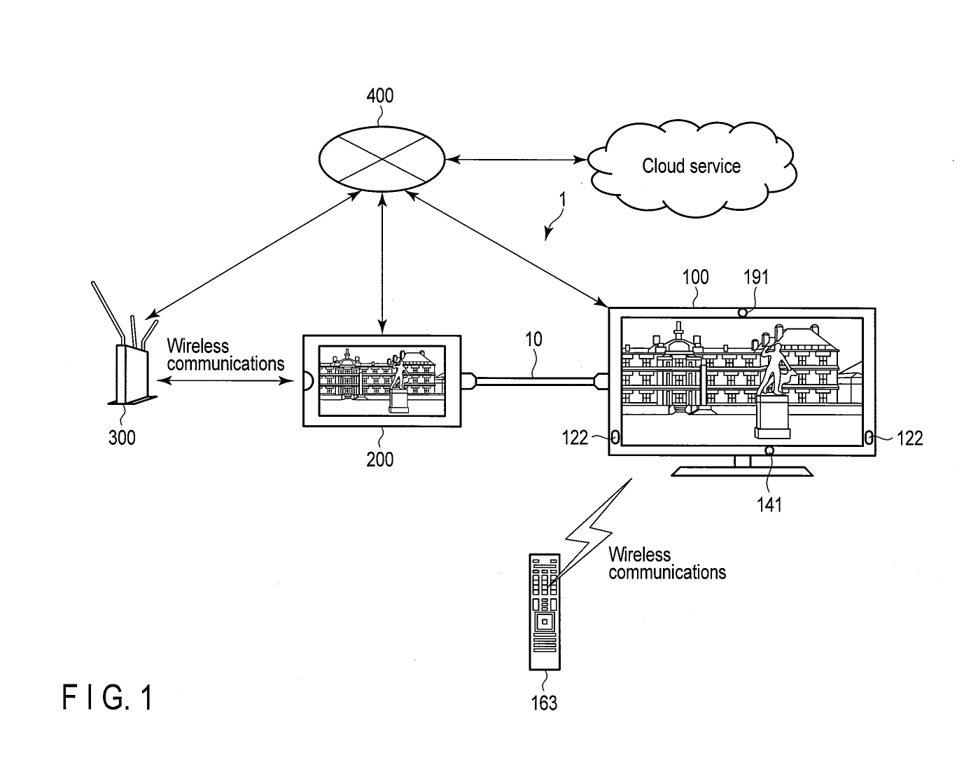

FIG. 1 shows an exemplary diagram of a transmitting and receiving system according to an embodiment. Elements and configurations which will be described below may be embodied either as software by a microcomputer (processor; central processing unit (CPU)) or as hardware. Contents to be displayed on a monitor can be arbitrarily acquired by using space waves (electronic waves), using a cable (including optical fiber) or a network such as an Internet Protocol communication network, processing a streaming video signal from a network, or using a video transfer technique that uses a network function, for example. A content will also be referred to as a stream, a program, or information, and includes video, speech, music, and the like. Video includes moving images, still images, texts (information expressed by characters, symbols, and the like represented by a coded string), and an arbitrary combination thereof.

A transmitting and receiving system 1 is formed of a plurality of electronic devices, such as an image receiving device (sink apparatus) 100, a control device (source apparatus) 200, and a wireless communication terminal 300, for example.

The image receiving device (sink apparatus) 100 is a broadcast receiver capable of reproducing a broadcast signal, a video content stored in a storage medium, and the like, or a video processing apparatus such as a video player (recorder) capable of recording and reproducing a content, for example. If the image receiving device 100 can be functioned as a sink apparatus, the image receiving device 100 may be a recorder (video recording apparatus) capable of recording and reproducing contents on and from an optical disk compatible with the Blu-ray Disc (BD) standard, an optical disk compatible with the digital versatile disk (DVD) standard and a hard disk drive (HDD), for example. If the device 100 can be functioned as a sink apparatus, may be a set-top box (STB) which receives contents and supplies the contents to the video processing apparatus, for example.

The control device (source apparatus) 200 is a mobile terminal device (hereinafter referred to as a mobile terminal), such as a mobile telephone terminal, a tablet personal computer (PC), a portable audio player, a handheld video game console, and the like, which includes a display, an operation module, and a communication module, for example.

The wireless communication terminal 300 is capable of performing wired or wireless communications with each of the image receiving device 100 and the mobile terminal 200. That is, the wireless communication terminal 300 functions as an access point (AP) of wireless communications of the image receiving device 100 or the mobile terminal 200. Further, the wireless communication terminal 300 is capable of connecting to a cloud service (a variety of servers), for example, via a network 400. That is, the wireless communication terminal 300 is capable of accessing the network 400 in response to a connection request from the image receiving device 100 or the mobile terminal 200. Thereby, the image receiving device 100 and the mobile terminal 200 are capable of acquiring a variety of data from a variety of servers on the network 400 (or a cloud service) via the wireless communication terminal 300.

The image receiving device 100 is mutually connected to the mobile terminal 200 via a communication cable (hereinafter referred to as MHL cable) 10 compatible with the Mobile High-Definition Link (MHL) standard. The MHL cable 10 is a cable including a High-Definition Digital Multimedia Interface (HDMI) terminal having a shape compatible with the HDMI standard on one end, and a Universal Serial Bus (USB) terminal having a shape compatible with the USB standard, such as the micro-USB standard, on the other end.

The MHL standard is an interface standard which allows the user to transmit moving image data (streams) including video and moving images. According to the MHL standard, an electronic device (Source apparatus (mobile terminal 200)) on the side that outputs a stream outputs a stream to an electronic device (Sink apparatus (image receiving device 100) on the side that receives a stream, via an MHL cable. The sink apparatus 100 is capable of causing the display to display video obtained by reproducing the received stream. Further, the source apparatus 200 and the sink apparatus 100 are capable of operating and controlling each other, by transmitting a command to the counterpart apparatus connected via the MHL cable 10. That is, according to the MHL standard, control similar to the current HDMI-Consumer Electronics Control (CEC) standard can be performed.

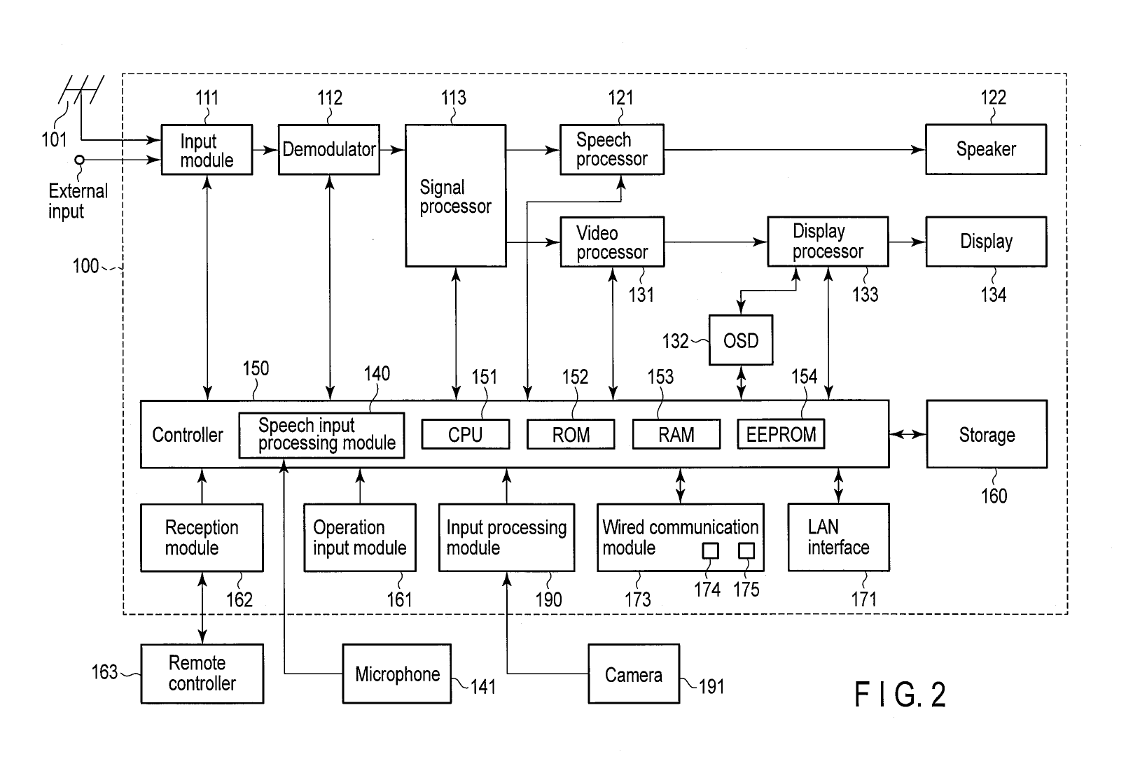

FIG. 2 shows an example of the video processing apparatus 100.

The video processing apparatus (image receiving device) 100 comprises an input module 111, a demodulator 112, a signal processor 113, a speech processor 121, a video processor 121, a video processor 131, an OSD processor 132, a display processor 133, a controller 150, a storage 160, an operation input module 161, a reception module 162, a LAN interface 171, and a wired communication module 173. The video processing apparatus 100 further comprises a speaker 122 and a display 134. The video processing apparatus 100 receives a control input (operation instruction) from a remote controller 163, and supplies the controller 150 with a control command corresponding to the operation instruction (control input).

The input module 111 is capable of receiving a digital broadcast signal which can be received via an antenna 101, for example, such as a digital terrestrial broadcast signal, a Broadcasting Satellite (BS) digital broadcast signal, and/or a communications satellite (CS) digital broadcast signal. The input module 111 is also capable of receiving a content (external input) supplied via an STB, for example, or as a direct input.

The input module 111 performs tuning (channel tuning) of the received digital broadcast signal. The input module 111 supplies the tuned digital broadcast signal to the demodulator 112. As a matter of course, the external input made via the STB, for example, is directly supplied to the demodulator 112.

The image receiving device 100 may comprise a plurality of input modules (tuners) 111. In that case, the image receiving device 100 is capable of receiving a plurality of digital broadcast signals/contents simultaneously.

The demodulator 112 demodulates the tuned digital broadcast signal/content. That is, the demodulator 112 acquires moving image data (hereinafter referred to as a stream) such as a TS (transport stream) from the digital broadcast signal/content. The demodulator 112 inputs the acquired stream to the signal processor 113. The video processing apparatus 100 may comprise a plurality of demodulators 112. The plurality of demodulators 112 are capable of demodulating each of a plurality of digital broadcast signals/contents.

As described above, the antenna 101, the input module 111, and the demodulator 112 function as reception means for receiving a stream.

The signal processor 113 performs signal processing such as a separation process on the stream. That is, the signal processor 113 separates a digital video signal, a digital speech signal, and other data signals, such as electronic program guides (EPGs) and text data formed of characters and codes called datacasting, from the stream. The signal processor 113 is capable of separating a plurality of streams demodulated by the plurality of demodulators 112.

The signal processor 113 supplies the speech processor 121 with the separated digital audio signal. The signal processor 113 supplies the video processor 131 with the separated digital video signal, also. Further, the signal processor 113 supplies a data signal such as EPG data to the controller 150.

Moreover, the signal processor 113 is capable of converting the stream into data (recording stream) in a recordable state on the basis of control by the controller 150. Further, the signal processor 113 is capable of supplying the storage 160 or other modules with a recording stream on the basis of control by the controller 150.

Still further, the signal processor 113 is capable of converting (transcoding) a bit rate of the stream from a bit rate set originally (in the broadcast signal/content) into a different bit rate. That is, the signal processor 113 is capable of transcoding (converting) the original bit rate of the acquired broadcast signal/content into a bit rate lower than the original bit rate. Thereby, the signal processor 113 is capable of recording a content (program) with less capacity.

The speech processor 121 converts a digital speech signal received by the signal processor 113 into a signal (audio signal) in a format that can be reproduced by the speaker 122. That is, the speech processor 121 includes a digital-to-analog (D/A) converter, and converts the digital speech signal into an analogue audio (acoustic)/speech signal. The speech processor 121 supplies the speaker 122 with the converted audio (acoustic)/speech signal. The speaker 122 reproduces the speech and the acoustic sound on the basis of the supplied audio (acoustic)/speech signal.

The video processor 131 converts the digital video signal from the signal processor 113 into a video signal in a format that can be reproduced by the display 134. That is, the video processor 131 decodes the digital video signal received from the signal processor 113 into a video signal in a format that can be reproduced by the display 134. The video processor 131 outputs the decoded video signal to the display processor 133.

The OSD processor 132 generates an On-Screen Display (OSD) signal for displaying a Graphical User Interface (GUI), subtitles, time, an application compatible/incompatible message, or notification information on incoming speech communication data or other incoming communication data similar thereto to the video and audio being reproduced, which is received by the mobile terminal 200, and the like, by superimposing such displays on a display signal from the video processor 131, on the basis of a data signal supplied from the signal processor 113, and/or a control signal (control command) supplied from the controller 150.

The display processor 133 adjusts color, brightness, sharpness, contrast, or other image qualities of the received video signal on the basis of control by the controller 150, for example. The display processor 133 supplies the display 134 with the video signal subjected to image quality adjusting. The display 134 displays video on the basis of the supplied video signal.

Further, the display processor 133 superimposes a display signal from the video processor 131 subjected to the image quality adjusting on the OSD signal from the OSD processor 132, and supplies the superimposed signal to the display 134.

The display 134 includes a liquid crystal display panel including a plurality of pixels arranged in a matrix pattern and a liquid crystal display device including a backlight which illuminates the liquid crystal panel, for example. The display 134 displays video on the basis of the video signal supplied from the display processor 133.

The image receiving device 100 may be configured to include an output terminal which outputs a video signal, in place of the display 134. Further, the image receiving device 100 may be configured to include an output terminal which outputs an audio signal, in place of the speaker 122. Moreover, the video processing apparatus 100 may be configured to include an output terminal which outputs a digital video signal and a digital speech signal.

The controller 150 functions as control means for controlling an operation of each element of the image receiving device 100. The controller 150 includes a CPU 151, a ROM 152, a RAM 153, an EEPROM (non-volatile memory) 154, and the like. The controller 150 performs a variety of processes on the basis of an operation signal supplied from the operation input module 161.

The CPU 151 includes a computing element, for example, which performs a variety of computing operations. The CPU 151 embodies a variety of functions by performing programs stored in the ROM 152, the EEPROM 154, or the like.

The ROM 152 stores programs for controlling the image receiving device 100, programs for embodying a variety of functions, and the like. The CPU 151 activates the programs stored in the ROM 152 on the basis of the operation signal supplied from the operation input module 161. Thereby, the controller 150 controls an operation of each element.

The RAM 153 functions as a work memory of the CPU 151. That is, the RAM 153 stores a result of computation by the CPU 151, data read by the CPU 151, and the like.

The EEPROM 154 is a non-volatile memory which stores a variety of setting information, programs, and the like.

The storage 160 includes a storage medium which stores contents. The storage 160 is, for example, a hard disk drive (HDD), a solid-state drive (SSD), a semiconductor memory, or the like. The storage 160 is capable of storing a recorded stream, text data, and the like supplied from the signal processor 113.

The operation input module 161 includes an operation key, a touchpad, or the like, which generates an operation signal in response to an operation input from the user, for example. The operation input module 161 may be configured to receive an operation signal from a keyboard, a mouse, or other input devices capable of generating an operation signal. The operation input module 161 supplies the controller 150 with the operation signal.

A touchpad includes a device capable of generating positional information on the basis of a capacitance sensor, a thermosensor, or other systems. When the image receiving device 100 comprises the display 134, the operation input module 161 may be configured to include a touch panel formed integrally with the display 134.

The reception module 162 includes a sensor, for example, which receives an operation signal from the remote controller 163 supplied by an infrared (IR) system, for example. The reception module 162 supplies the controller 150 with the received signal. The controller 150 receives the signal supplied from the reception module 162, amplifies the received signal, and decodes the original operation signal transmitted from the remote controller 163 by performing an analog-to-digital (A/D) conversion of the amplified signal.

The remote controller 163 generates an operation signal on the basis of an operation input from the user. The remote controller 163 transmits the generated operation signal to the reception module 162 via infrared communications. The reception module 162 and the remote controller 163 may be configured to transmit and receive an operation signal via other wireless communications using radio waves (RF), for example.

The local area network (LAN) interface 171 is capable of performing communications with other devices on the network 400 via the wireless communication terminal 300 by a LAN or a wireless LAN. Thereby, the video processing apparatus 100 is capable of performing communications with other devices connected to the wireless communication terminal 300. For example, the image receiving device 100 is capable of acquiring a stream recorded in a device on the network 400 via the LAN interface 171, and reproducing the acquired stream.

The wired communication module 173 is an interface which performs communications on the basis of standards such as HDMI and MHL. The wired communication module 173 includes an HDMI terminal, not shown, to which an HDMI cable or an MHL cable can be connected, an HDMI processor 174 configured to perform signal processing on the basis of the HDMI standard, and an MHL processor 175 configured to perform signal processing on the basis of the MHL standard.

A terminal of the MHL cable 10 on the side that is connected to the image receiving device 100 has a structure compatible with the HDMI cable. The MHL cable 10 includes a resistance between terminals (detection terminals) that are not used for communications. The wired communication module 173 is capable of determining whether the MHL cable or the HDMI cable is connected to the HDMI terminal by applying a voltage to the detection terminals.

The image receiving device 100 is capable of receiving a stream output from a device (Source apparatus) connected to the HDMI terminal of the wired communication module 173 and reproducing the received stream. Further, the image receiving device 100 is capable of outputting a stream to the device (Sink apparatus) connected to the HDMI terminal of the wired communication module 173.

The controller 150 supplies a stream received by the wired communication module 173 to the signal processor 113. The signal processor 113 separates a digital video signal, a digital speech signal, and the like from the received (supplied) stream. The signal processor 113 transmits the separated digital video signal to the video processor 131, and the separated digital speech signal to the speech processor 121. Thereby, the image receiving device 100 is capable of reproducing the stream received by the wired communication module 173.

The image receiving device 100 further comprises a power-supply section, not shown. The power-supply section receives power from a commercial power source, for example, via an AC adaptor, for example. The power-supply section converts the received alternating-current power into direct-current power, and supplies the converted power to each element of the image receiving device 100.

The image receiving device 100 includes an input processing module 190, a microphone 191 connected to the input processing module 190, and a camera 192. Speech information acquired by the microphone 191 or an image (of the user) acquired by the camera 192 is input to the controller 150 via the input processing module 190, and is subjected to predetermined processing and digital signal processing by the signal processor 113 connected to the controller 150.

Further, the image receiving device 100 includes a speech processor 180 connected to the controller 150, and is capable of processing start and end of a call on the basis of speech information acquired by the microphone 191.

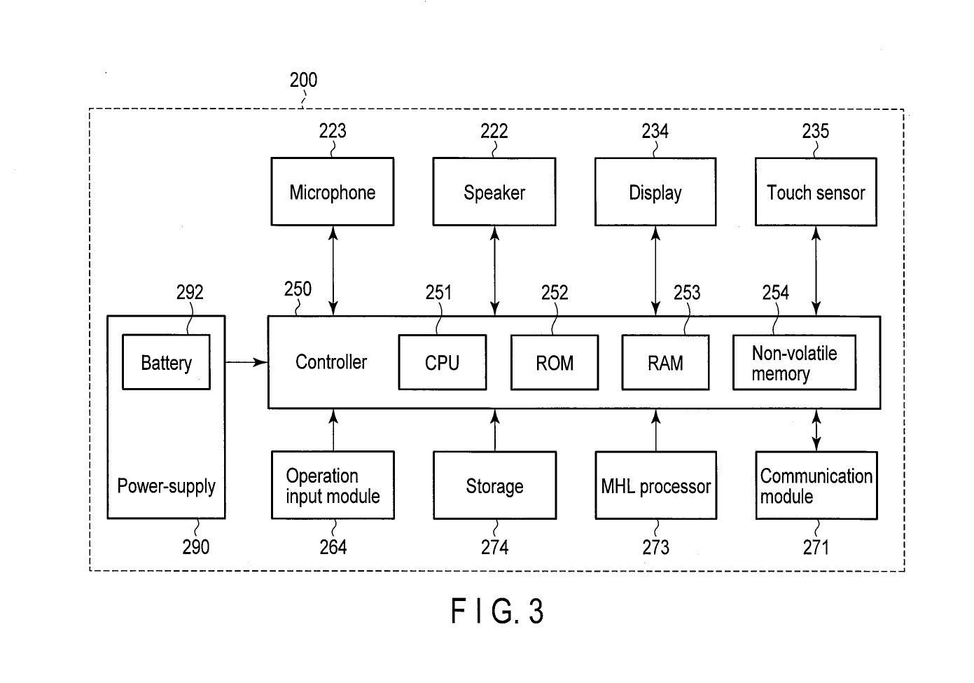

FIG. 3 shows an exemplary diagram of the mobile terminal 200.

The mobile terminal (cooperating device) 200 comprises a controller 250, an operation input module 264, a communication module 271, an MHL processor 273, and a storage 274. Further, the mobile terminal 200 comprises a speaker 222, a microphone 223, a display 234, and a touch sensor 235.

The control module 250 functions as a controller configured to control an operation of each element of the mobile terminal 200. The control module 250 includes a CPU 251, a ROM 252, a RAM 253, a non-volatile memory 254, and the like. The control module 250 performs a variety of operations on the basis of an operation signal supplied from the operation input module 264 or the touch sensor 235. The control module 250 also performs control of each element corresponding to a control command supplied from the image receiving device 100 via the MHL cable 10, activation of an application, and a process (execution of the function) supplied by the application (which may be performed by the CPU 251).

The CPU 251 includes a computing element configured to execute a variety of computing operations. The CPU 251 embodies a variety of functions by executing programs stored in the ROM 252 or the non-volatile memory 254, for example.

Further, the CPU 251 is capable of performing a variety of processes on the basis of data such as applications stored in the storage device 274. The CPU 251 also performs control of each element corresponding to a control command supplied from the image receiving device 100 via the MHL cable 10, activation of an application, and a process supplied by the application (execution of the function).

The ROM 252 stores programs for controlling the mobile terminal 200, programs for embodying a variety of functions, and the like. The CPU 251 activates the programs stored in the ROM 252 on the basis of an operation signal from the operation input module 264. Thereby, the controller 250 controls an operation of each element.

The RAM 253 functions as a work memory of the CPU 251. That is, the RAM 253 stores a result of computation by the CPU 251, data read by the CPU 251, and the like.

The non-volatile memory 254 is a non-volatile memory configured to store a variety of setting information, programs, and the like.

The controller 250 is capable of generating a video signal to be displayed on a variety of screens, for example, according to an application being executed by the CPU 251, and causes the display 234 to display the generated video signal. The display 234 reproduces moving images (graphics), still images, or character information on the basis of the supplied moving image signal (video). Further, the controller 250 is capable of generating an audio signal to be reproduced, such as various kinds of speech, according to the application being executed by the CPU 251, and causes the speaker 222 to output the generated speech signal. The speaker 222 reproduces sound (acoustic sound/speech) on the basis of a supplied audio signal (audio).

The microphone 223 collects sound in the periphery of the mobile terminal 200, and generates an acoustic signal. The acoustic signal is converted into acoustic data by the control module 250 after A/D conversion, and is temporarily stored in the RAM 253. The acoustic data is converted (reproduced) into speech/acoustic sound by the speaker 222, after D/A conversion, as necessary. The acoustic data is used as a control command in a speech recognition process after A/D conversion.

The display 234 includes, for example, a liquid crystal display panel including a plurality of pixels arranged in a matrix pattern and a liquid crystal display device including a backlight which illuminates the liquid crystal panel. The display 234 displays video on the basis of a video signal.

The touch sensor 235 is a device configured to generate positional information on the basis of a capacitance sensor, a thermo-sensor, or other systems. The touch sensor 235 is provided integrally with the display 234, for example. Thereby, the touch sensor 235 is capable of generating an operation signal on the basis of an operation on a screen displayed on the display 234 and supplying the generated operation signal to the controller 250.

The operation input module 264 includes a key which generates an operation signal in response to an operation input from the user, for example. The operation input module 264 includes a volume adjustment key for adjusting the volume, a brightness adjustment key for adjusting the display brightness of the display 234, a power key for switching (turning on/off) the power states of the mobile terminal 200, and the like. The operation input module 264 may further comprise a trackball, for example, which causes the mobile terminal 200 to perform a variety of selection operations. The operation input module 264 generates an operation signal according to an operation of the key, and supplies the controller 250 with the operation signal.

The operation input module 264 may be configured to receive an operation signal from a keyboard, a mouse, or other input devices capable of generating an operation signal. For example, when the mobile terminal 200 includes a USB terminal or a module which embodies a Bluetooth (registered trademark) process, the operation input module 264 receives an operation signal from an input device connected via USB or Bluetooth, and supplies the received operation signal to the controller 250.

The communication module 271 is capable of performing communications with other devices on the network 400 via the wireless communication terminal 300, using a LAN or a wireless LAN. Further, the communication module 271 is capable of performing communications with other devices on the network 400 via a portable telephone network. Thereby, the mobile terminal 200 is capable of performing communications with other devices connected to the wireless communication terminal 300. For example, the mobile terminal 200 is capable of acquiring moving images, pictures, music data, and web content recorded in devices on the network 400 via the communication module 271 and reproducing the acquired content.

The MHL processor 273 is an interface which performs communications on the basis of the MHL standard. The MHL processor 273 performs signal processing on the basis of the MHL standard. The MHL processor 273 includes a USB terminal, not shown, to which an MHL cable can be connected.

The mobile terminal 200 is capable of receiving a stream output from a device (source apparatus) connected to the USB terminal of the MHL processor 273, and reproducing the received stream. Further, the mobile terminal 200 is capable of outputting a stream to a device (sink apparatus) connected to the USB terminal of the MHL processor 273.

Moreover, the MHL processor 273 is capable of generating a stream by superimposing a video signal to be displayed on a speech signal to be reproduced. That is, the MHL processor 273 is capable of generating a stream including video to be displayed on the display 234 and audio to be output from the speaker 222.

For example, the controller 250 supplies the MHL processor 273 with a video signal to be displayed and an audio signal to be reproduced, when an MHL cable is connected to the USB terminal of the MHL processor 273 and the mobile terminal 200 operates as a source apparatus. The MHL processor 273 is capable of generating a stream in a variety of formats (for example, 1080i and 60 Hz) using the video signal to be displayed and the audio signal to be reproduced. That is, the mobile terminal 200 is capable of converting a display screen to be displayed on the display 234 and audio to be reproduced by the speaker 222 into a stream. The controller 250 is capable of outputting the generated stream to the sink apparatus connected to the USB terminal.

The mobile terminal 200 further comprises a power-supply 290. The power-supply 290 includes a battery 292, and a terminal (such as a DC jack) for connecting to an adaptor which receives power from a commercial power source, for example. The power-supply 290 charges the battery 292 with the power received from the commercial power source. Further, the power-supply 290 supplies each element of the mobile terminal 200 with the power stored in the battery 292.

The storage 274 includes a hard disk drive (HDD), a solid-state drive (SSD), a semiconductor memory, and the like. The storage 274 is capable of storing content such as programs, applications, moving images that are executed by the CPU 251 of the controller 250, a variety of data, and the like.

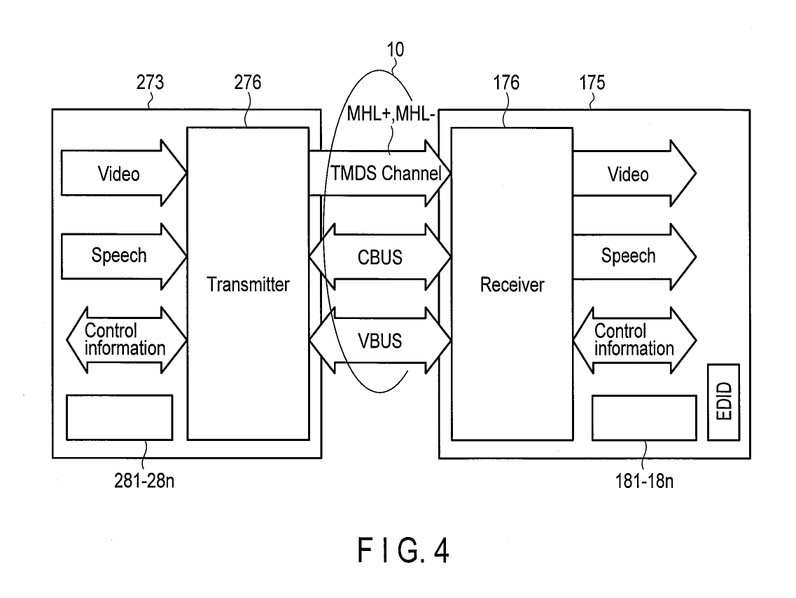

FIG. 4 is an exemplary diagram illustrating mutual communications between the electronic devices based on the MHL standard. In FIG. 4, the mobile terminal 200 is a source apparatus, and the image receiving device 100 is a sink apparatus, by way of example.

The MHL processor 273 of the mobile terminal 200 includes a transmitter 276 and a receiver, not shown. The MHL processor 175 of the image receiving device 100 includes a transmitter (not shown) and a receiver 176.

The transmitter 276 and the receiver 176 are connected via the MHL cable 10.

When a Micro-USB terminal is applied as a connector at the time of implementation, the MHL cable is formed of the following 5 lines: a VBUS (power) line; an MHL−(differential pair [−(negative)] line; an MHL+(differential pair [+(positive)] line; a CBUS (control signal) line, and a GND (ground) line.

The VBUS line supplies power from the sink apparatus to the source apparatus (functions as a power line). That is, in the connection of FIG. 4, the sink apparatus (power supplying source (image receiving device 100)) supplies the source apparatus (mobile terminal 200) with power of +5V via the VBUS line. Thereby, the sink apparatus is capable of operating using the power supplied from the sink apparatus (via the VBUS line). The mobile terminal 200 as the source apparatus operates using power supplied from the battery 292, during independent operation. When the mobile terminal 200 is connected to the sink apparatus via the MHL cable 10, on the other hand, the battery 292 can be charged with the power supplied via the VBUS line from the sink apparatus.

The CBUS line is used for bi-directionally transmitting a Display Data Channel (DDC) command, an MHL sideband channel (MSC) command, or an arbitrary control command(s) corresponding to application(s), for example.

A DDC command is used for reading of data (information) stored in extended display identification data (EDID), which is information set in advance for notifying the counterpart apparatus of a specification (display ability) in a display, and recognition of High-bandwidth Digital Content Protection (HDCP), which is a system for encrypting a signal transmitted between the apparatuses, for example.

An MSC command is used for, for example, reading/writing a variety of resistors, transmitting MHL-compatible information and the like in an application stored in the counterpart device (cooperating device), notifying the image receiving device 100 of an incoming call when the mobile terminal receives the incoming call, and the like. That is, the MSC command can by the image receiving device 100 to read MHL-compatible information of the application stored in the mobile terminal 200, activate the application, make an incoming call notification (notification of an incoming call), and the like.

As described above, the image receiving device 100 as a sink apparatus outputs a predetermined control command, MHL-compatible information, and the like to the mobile terminal 200 as a source apparatus via the CBUS line. Thereby, the mobile terminal 200 is capable of performing a variety of operations in accordance with a received command (when compatible with MHL).

That is, the mobile terminal 200 (source apparatus) transmits a DDC command to the image receiving device 100 (sink apparatus), thereby performing HDCP recognition between the source apparatus and the sink apparatus and reading EDID from the sink apparatus. Further, the image receiving device 100 and the mobile terminal 200 transmit and receive a key, for example, in a procedure compliant with HDCP, and perform mutual recognition.

When the source apparatus (mobile terminal 200) and the sink apparatus (image receiving device 100) are recognized by each other, the source apparatus and the sink apparatus are capable of transmitting and receiving encrypted signals to and from each other. The mobile terminal 200 reads the EDID from the image receiving device 100 in the midst of HDCP recognition with the image receiving device 100. Reading (acquisition) of the EDID may be performed at independent timing different from that of HDCP recognition.

The mobile terminal 200 analyzes the EDID acquired from the image receiving device 100, and recognizes display information indicating a format including a resolution, a color depth, a transmission frequency, and the like that can be processed by the image receiving device 100. The mobile terminal 200 generates a stream in a format including a resolution, a color depth, a transmission frequency, and the like that can be processed by the image receiving device 100.

The MHL+ and the MHL− are lines for transmitting data. The two lines of MHL+ and the MHL− function as a twist pair. For example, the MHL+ and the MHL− function as a transition minimized differential signaling (TMDS) channel which transmits data in the TMDS system. Further, the MHL+ and the MHL− are capable of transmitting a synchronization signal (MHL clock) in the TMDS system.

For example, the mobile terminal 200 is capable of outputting a stream to the image receiving device 100 via the TMDS channel. That is, the mobile terminal 200 which functions as the source apparatus is capable of transmitting a stream obtained by converting video (display screen) to be displayed on the display 234 and the audio to be output from the speaker 222 to the image receiving device 100 as the sink apparatus. The image receiving device 100 receives the stream transmitted using the TMDS channel, performs signal processing of the received stream, and reproduces the stream.

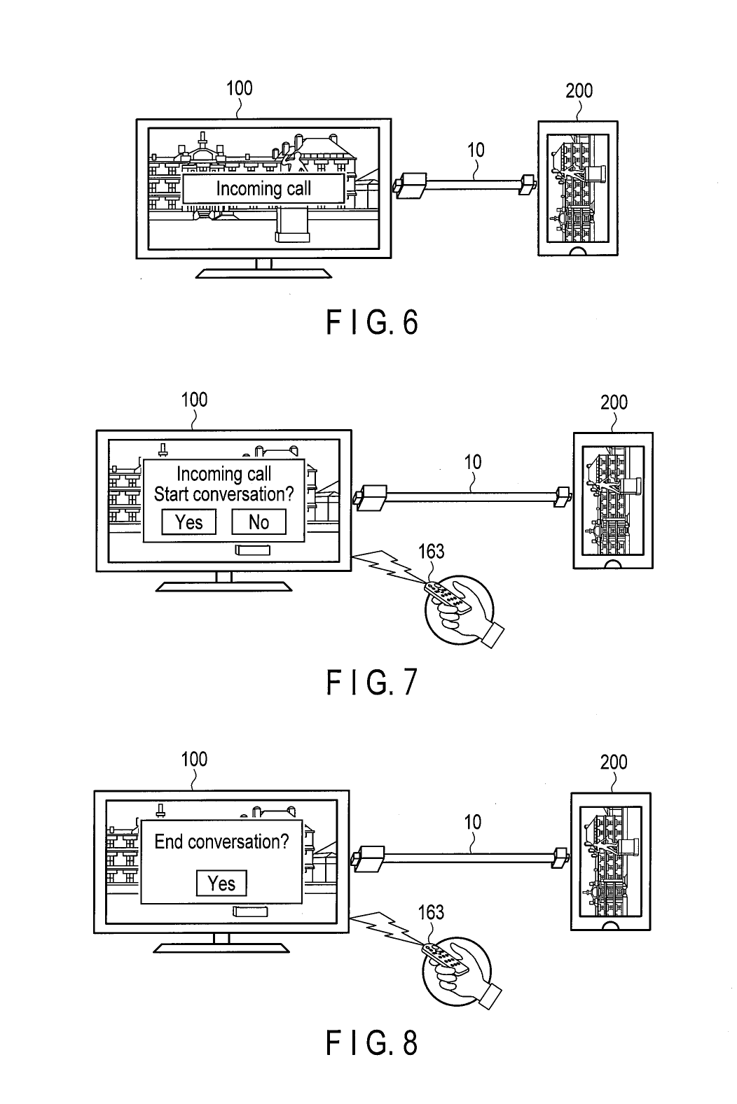

When the mobile terminal 200 receives incoming speech communication data or other incoming communication data similar thereto, the level (output) of a speech component of a stream to be transmitted to the image receiving device 100 is changed, for example, as will be described later with reference to FIGS. 6-14. For example, the speech component is muted (speech output is set to substantially “0”). It may well, to select not answer for incoming call communication (no answer) of the mobile terminal 200.

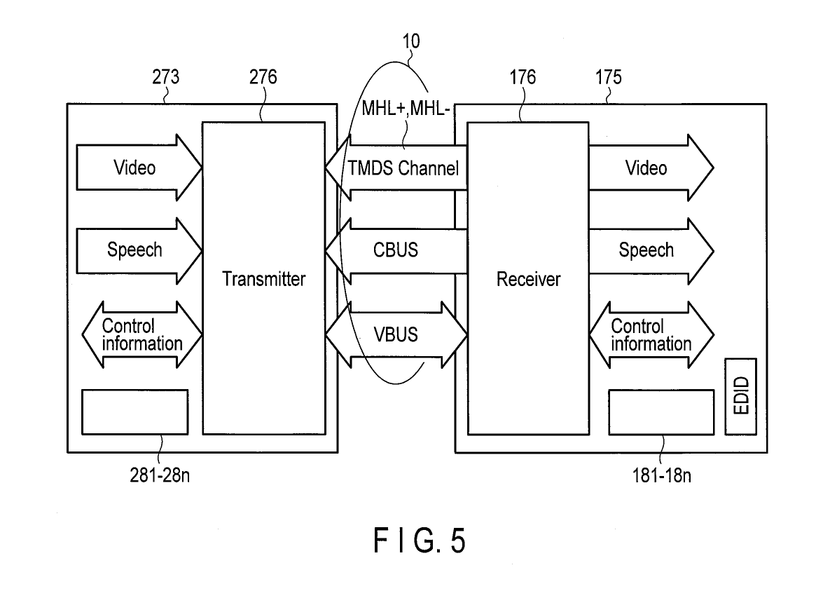

FIG. 5 is an exemplary diagram of the embodiment applied to mutual communications between the electronic apparatuses shown in FIG. 4.

In the embodiment shown in FIG. 5, an MSC command is supplied from the image receiving device 100 to the mobile terminal 200 via the CBUS line. Further, names of applications stored in the mobile terminal 200 (and MHL-compatible information of each application) can be read (acquired) from the image receiving device 100. It is to be noted that the HDCP recognition and EDID acquisition described with reference to FIG. 4 have been completed before the control command (MSC command) is supplied (transmitted) and the MHL-compatible information is read (acquired).

When the mobile terminal 200 receives incoming speech communication data or other incoming communication data similar thereto, the mobile terminal 200 receives a control instruction such as “Hold” from the image receiving device 100, and performs a corresponding process (execution of the function), as will be described later with reference to FIGS. 6-14.

Control of transmission (transfer) of a stream when the mobile terminal 200 receives incoming speech communication data or other incoming communication data similar thereto (hereinafter referred to as a call) is unique to the mobile terminal 200. Control of transmission (transfer) of a stream when an incoming call is received depends on the processing ability and the function of the mobile terminal 200 and the policy of the manufacturer. In general control, however, transmission of a stream is stopped at the point in time when an incoming call is received and the call is given priority. In that case, in order to recognize the reason why reproduction of video and audio has been stopped in the image receiving device 100, it is necessary for the user who is viewing and listening to the video and audio (stream) being reproduced by the image receiving device 100 to determine the cause. When the mobile terminal 200 is placed in a position that can be viewed by the user, it is relatively easy to recognize an incoming call by performing operations of displaying a display of the mobile terminal 200 or turning on a light (of the display). When the mobile terminal 200 is not placed in a position that can be viewed by the user (when the mobile terminal 200 is not under the care (of the user)). On the other hand, the reason why reproduction of the video and audio has been stopped in the image receiving device 100 remains unknown, until an incoming call can be recognized.

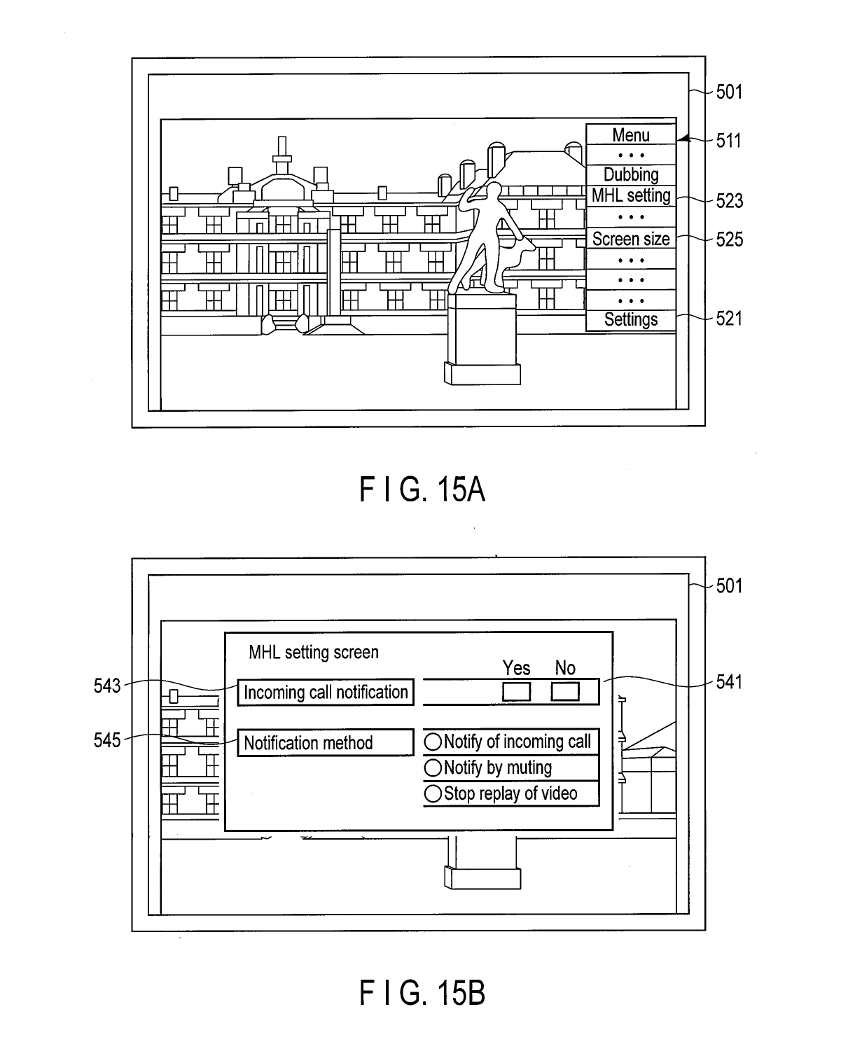

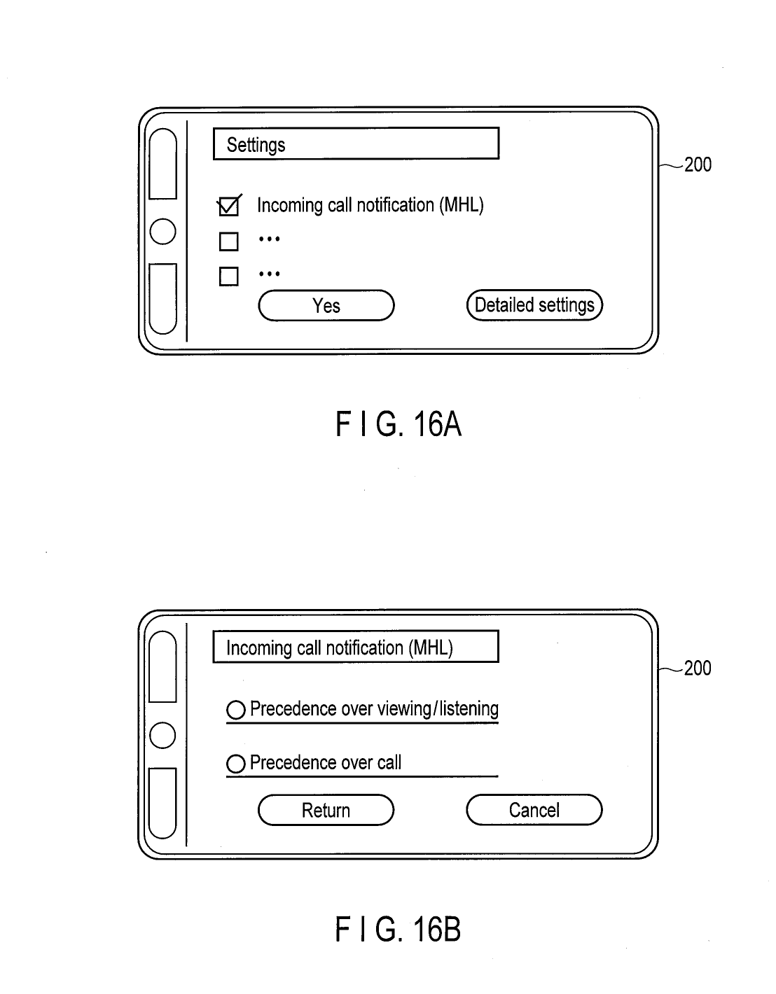

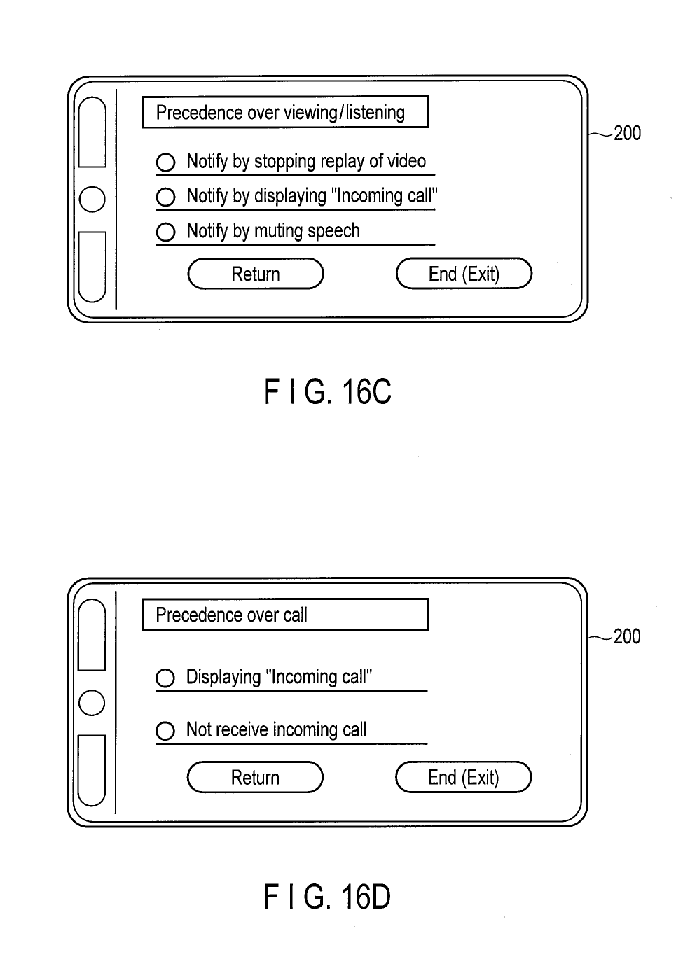

When the mobile terminal 200 connected to the image receiving device 100 receives an incoming call via the MHL cable 10 according to the embodiment under the above-described background will be described step by step with reference to FIGS. 6-14. Transmission (transfer) of a stream from the mobile terminal 200 to the image receiving device 100 or notification of an incoming call to the video and audio being reproduced that is displayed on the image receiving device 100. Transmission (transfer) of a stream from the mobile terminal 200 to the image receiving device 100 or notification of an incoming call to the video and audio being reproduced that is displayed on the image receiving device 100, which will be described later, can be arbitrarily (individually among the mobile terminals 200) set in the image receiving device 100 or on the side of the mobile terminal 200, in accordance with a setting method that will be described later with reference to FIGS. 15A, 15B, 16A, 16B, 16C and 16D.

FIG. 6 illustrates an example of display in which, when the mobile terminal connected to the image receiving device has received an incoming call, receipt of the incoming call is displayed for notification in a screen display of the image receiving device which is reproducing a stream.

In the example of FIG. 6, a screen display (notification screen) of a stream being reproduced by the image receiving device 100 corresponding to a result of the mobile terminal 200 receiving an incoming call and notifying the image receiving device 100 of the receipt of the incoming call (from the mobile terminal 200) via an MSC command is shown. In this example, audio (speech) reproduction is not changed, and only a message such as “Incoming call” is displayed on the screen display. The incoming call notification (such as “Incoming call”) can be easily embodied by superimposing an OSD signal corresponding to a display example of an incoming call notification prepared in advance on a video signal of a stream being reproduced from the OSD processor 132.

That is, in the example shown in FIG. 6, by being notified of receipt of an incoming call in the screen display of the image receiving device which is reproducing a stream, the user is capable of recognizing that the mobile terminal 200, which functions as a transmitter of the stream, has received the incoming call.

FIG. 7 illustrates an example of display in which receipt of an incoming call and an option to answer the call are displayed for notification in a screen display of an image receiving device that is reproducing a stream, when a mobile terminal connected to the image receiving device has received the incoming call.

FIG. 7 shows an example of a screen display (notification screen) of the image receiving device 100, which is reproducing a stream, corresponding to a result of the mobile terminal 200 receiving an incoming call and the image receiving device 100 being notified of the receipt of the incoming call (from the mobile terminal 200) via an MSC command, for example. In this example, an indication including an incoming call notification such as “Incoming call”, a message such as “Start conversation?”, and two buttons, which allow the user to enter a command that selects “YES”, i.e., start of a conversation (answer to a call) or a command that selects “NO”, i.e., rejection of a call, are displayed on the screen display, without changes to reproduction of audio (speech). The image display (such as “Incoming call”) can be easily embodied by superimposing an OSD signal corresponding to a display example of an incoming call notification prepared in advance on a video signal of a stream being reproduced by the OSD processor 132. Further, the buttons can be easily embodied by superimposing an OSD signal on a video signal of a stream being reproduced by the OSD processor 132, as in the case of the incoming call notification. Switching is made between start of a conversation and rejection of a call displayed on the image receiving device 100 on the basis of operation of the remote controller 163 corresponding to each button (input to answer the call (instruction input to “Yes” button) or reject the call (instruction input to “No” button)). When a command to select “Yes”, i.e., start of a conversation (answer to a call), is entered so as to answer a call in the display of the incoming call notification shown in FIG. 7, the image receiving device 100 can be structured such that a call end screen including “End conversation?” message and “Yes (Exit)” button is displayed as shown in FIG. 8, for example, and answering and ending the incoming call received by the mobile terminal 200 can be controlled only by the operation of the remote controller 163. In that case, the conversation is processed via a microphone 141 and a speech input processing module 140 included in the image receiving device 100, for example, supplied to the mobile terminal 200 via the MHL cable 10, and is transmitted to the caller from the mobile terminal 200. Speech from the caller for speech is input to the image receiving device 100 via the MHL cable 10, and is output from the speaker 122.

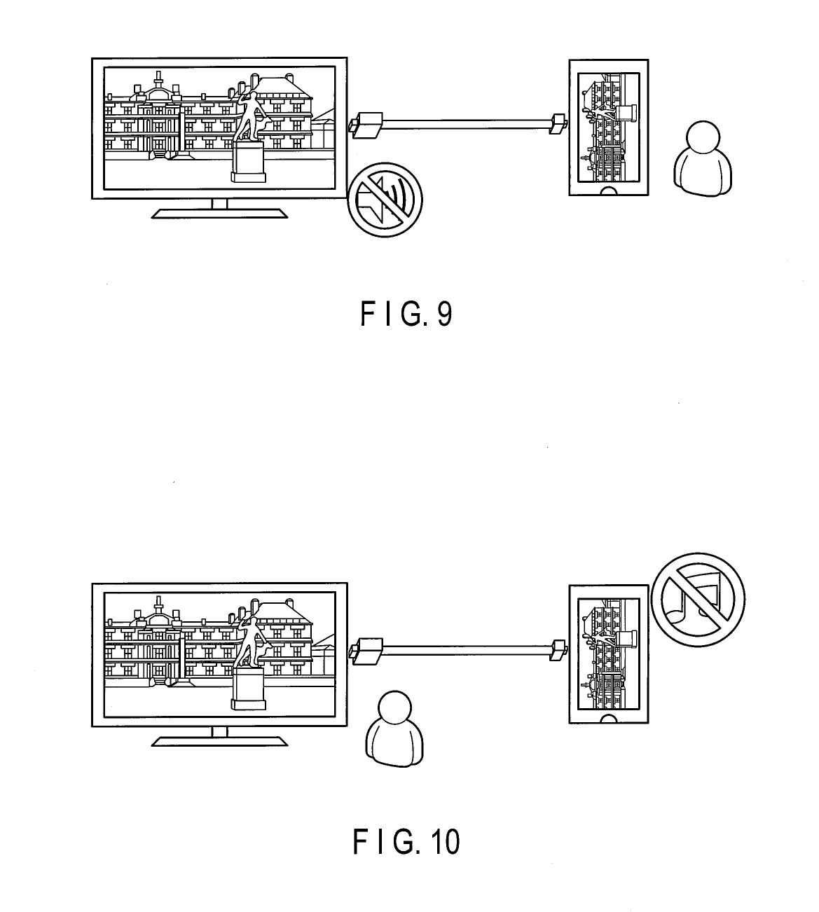

When the incoming call notification shown in FIGS. 6 and 7 is displayed and if “conversation priority” is set in “Settings” that will be described later, an audio (speech) output of a stream being reproduced is silenced (muted), as shown in FIG. 9. For example, when “conversation priority” is set, it is possible to reduce the level of the output speech of the image receiving device 100 after elapse of a predetermined period of time, e.g., approximately 2 seconds, after display of the incoming call notification, or perform a muting process simultaneously with display of the incoming call notification. It is also possible to reduce the level of the output speech step by step at the time of muting. When “video priority” is set, to cancel a ringtone and a message (speech output) making a notification that an incoming call is being received in the mobile terminal 200, as shown in FIG. 10, preferably. It is still possible to display the incoming call notification shown in FIG. 6 even when “video priority” is set. In that case, it is preferable to perform, in combination therewith, processes of displaying an incoming call notification in a predetermined position, e.g., at one of the four corners in the screen display of the image receiving device 100, restricting (reducing) the display size to a size that causes little effect to visual recognition of video of a stream being reproduced, and increasing transmittance at the time of OSD display (displaying video of a stream being reproduced as an OSD at the background in a transparent state).

It is also possible to prepare an incoming call notification, or the like, to be displayed on the image receiving device 100 as a video signal in advance in the mobile terminal 200 and supply the video signal to the image receiving device 100 via the MHL cable 10.

When start of a call (operation (in response to “Yes” button)) is instructed in the incoming call notification shown in FIG. 7, the speech (audio) reproduction may be controlled by reducing the level of the output speech of the image receiving device 100 after elapse of a predetermined period of time after display of the incoming call notification, or by performing a silencing (muting) process simultaneously with the display of the incoming call notification, for example, as in the example described with reference to FIG. 9. As a matter of course, it is also possible to perform control to reduce the level of the output speech step by step at the time of silencing, for example.

If, an incoming call has ended, it is also possible to perform a process to return the level of the output speech of the image receiving device 100 to the original level at predetermined timing or step by step (in a manner similar to the operation of pressing and keeping a volume-up key of the remote controller 163).

A process similar to the silencing (muting) process of the audio (speech) output described with reference to FIG. 9 may be performed not only at the time of receiving a call but also at the time of making a call. That is, when the user starts a call operation with the mobile terminal 200, to perform a process of reducing the level of the output speech or a muting process in the image receiving device 100, preferably. As a matter of course, it is also possible to perform control to reduce the level of the output speech step by step at the time of silencing, for example.

When, answered to an incoming call, to stop output (transmission) of a stream from the mobile terminal 200 or stop (temporarily suspend) reproduction of video and speech by the image receiving device 100, preferably. That is, when answered to an incoming call, it is preferable to stop transmission of a stream by the mobile terminal 200 or suspend reproduction of a stream by the image receiving device 100.

Further, it is preferable to start transmission of the interrupted stream (on the side of the mobile terminal 200) or reproduction of the temporarily suspended stream (on the side of the image receiving device 100) at the point in time when the call has ended. In consideration of the amount of power consumption of the mobile terminal 200, it is preferable to temporarily quit an application (program) that processes transmission (reproduction) of a stream when an incoming call is answered. Therefore, when output of a video/speech signal (transmission of a stream) is automatically restarted in the mobile terminal 200 after end of the call, it is preferable to resume using a resume function and return to the state immediately before the conversation is started (such as an application activation state or an output transmission state) at the time of restarting output of the video/speech signal, for example.

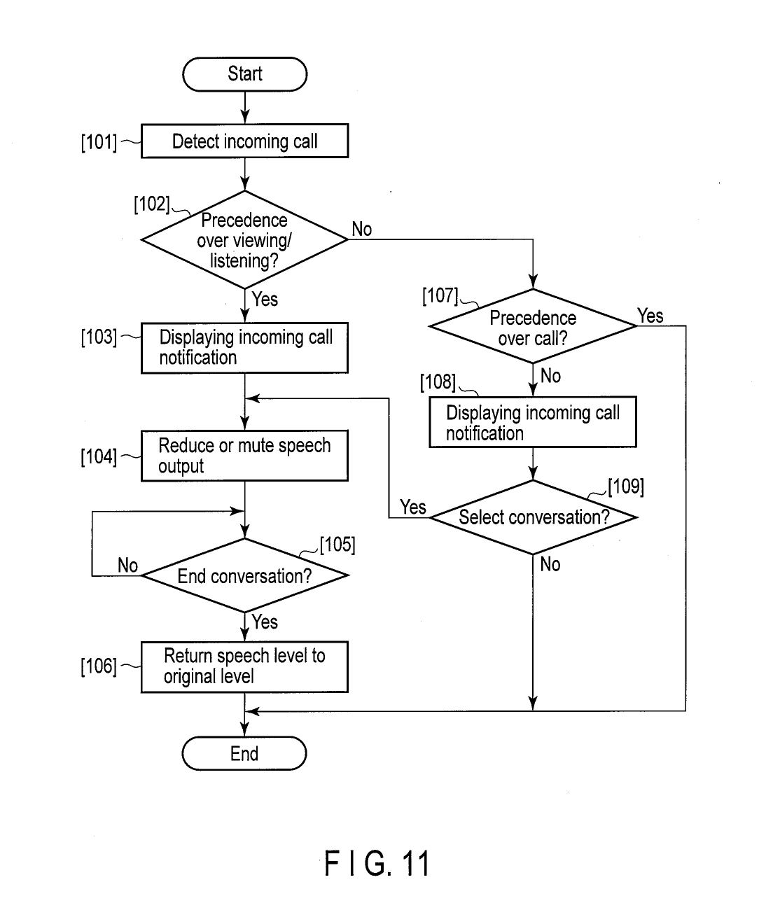

FIG. 11 illustrates an example of processing the level of the output speech of a call in the image receiving device described with reference to FIG. 6 or 9 in terms of software.

When an incoming call is detected [101] and “precedence over viewing/listening” is set with respect to speech output of the image receiving device [102—YES], displaying the incoming call notification[103], as shown in FIG. 6. Following the displaying the incoming call notification, or after elapse of a predetermined period of time after the display, the speech output is reduced in level or muted [104].

At the point in time when end of a conversation is detected [105—YES], the speech output is returned to the original level [106].

When a setting different from “precedence over viewing/listening” is made with respect to the speech output of the image receiving device [102—NO] and when “precedence over call” is detected [107—YES], on the other hand, the state (settings) before the detection of the incoming call is maintained with respect to video display and speech reproduction in the image receiving device. That is, a notification is not made on an incoming call. When the setting is different from “precedence over call” [107—NO], displaying the incoming call notification[108], and when “select call” is selected in the displaying [108] of the incoming call notification[109—YES], the speech output is reduced in level or muted following the display of the indication of the incoming call notification or after elapse of a predetermined period of time after the display [104]. At the point in time when end of a conversation is detected [105—YES], the speech output is returned to the original level [106]. When “select call” is not selected (a call is not answered) in the indication of the incoming call notification[108]-[109—NO], the OSD display of the incoming call notification of an incoming call is removed from video of a stream being reproduced by the image receiving device.

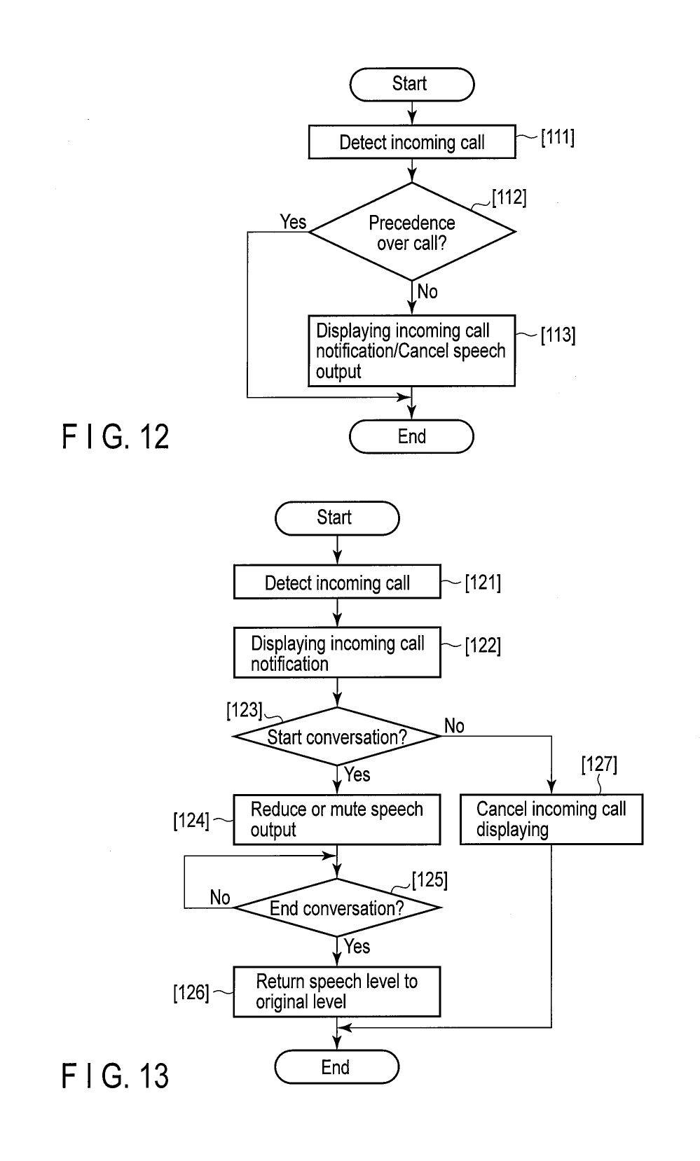

FIG. 12 illustrates an example of processing the level of the output speech of a call in the image receiving device shown in FIG. 6 or 10 in terms of software.

When an incoming call is detected [111] and if “precedence over viewing/listening” is set with respect to the speech output of the image receiving device [112—YES], displaying the incoming call notification, as shown in FIG. 10, and a ringtone output by the mobile terminal 200 and a message (speech output) making a notification that the incoming call is being received is canceled [113].

When “Decline for call” is set with respect to the speech output of the image receiving device [112—NO], it is preferable not to display an OSD of an incoming call notification of an incoming call (not to make a notification of an incoming call) in video of a stream being reproduced by the image receiving device.

FIG. 13 illustrates an example of processing the level of the output speech of a call in the image receiving device described with reference to FIG. 7 or 9 in terms of software.

When “precedence over viewing/listening” is set with respect to the speech output of the image receiving device and when an incoming call is detected [121], displaying the incoming call notification[122], as shown in FIG. 6 or 7. When start of a conversation (operation (in response to “Yes” button)) is instructed in response to the indication of the incoming call notification[123—YES], the speech output is reduced in level or muted after elapse of a predetermined period of time after display of the incoming call notification [124]. Note that after displaying the incoming call notification shown in FIG. 7 and “answering selection”, at a predetermined timing, the call end screen including “End conversation?” message and “Yes (Exit)” button, as shown in FIG. 8, can be displayed so that the finishing of the conversation of the incoming call received by the mobile terminal 200 can be entered only by the operation of the remote controller 163.

At the point in time when end of a conversation is detected [125—YES], the speech output is returned to the original level [126].

When “No”, i.e., rejection of a decline for call is instructed in response to the indication of the incoming call notification[123—NO], on the other hand, the indication of an incoming call notification displayed as an OSD in video of a stream being reproduced by the image receiving device is cancelled [127].

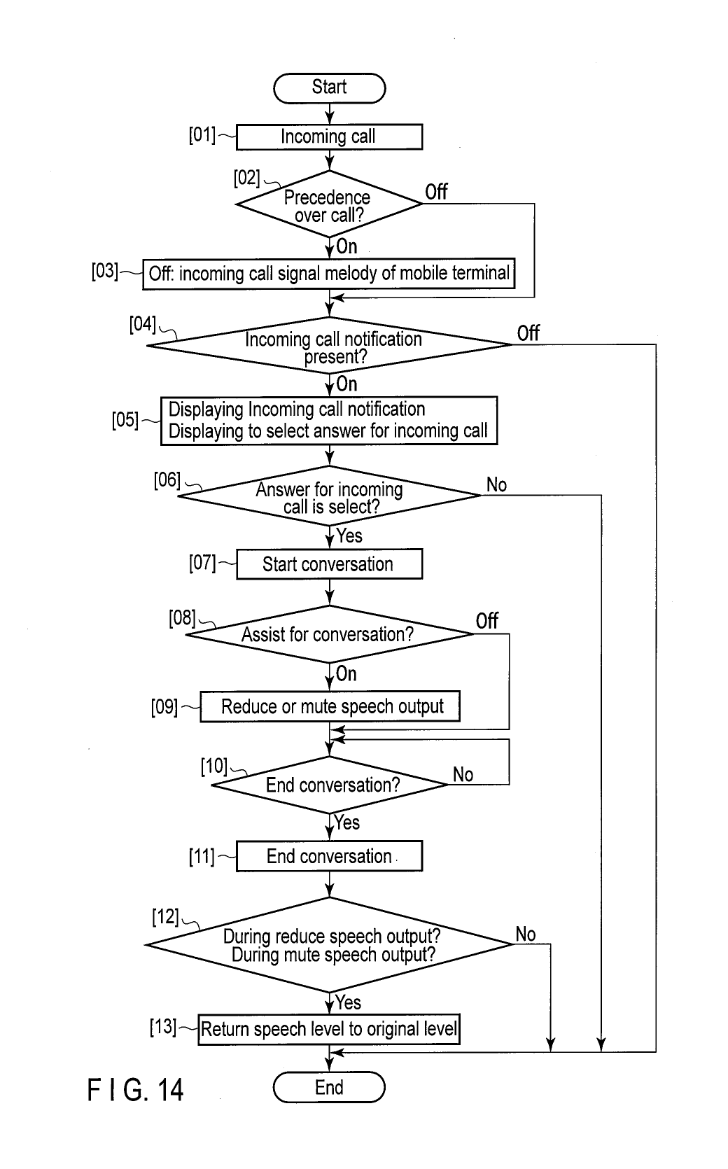

FIG. 14 further illustrates a series of operations in association with each of the operations (display examples) of the image receiving device and the mobile terminal shown in FIGS. 6 to 10 by way of example.

FIG. 14 further illustrates transmission (transfer) of a stream from a mobile terminal, which is connected to the image receiving device via an MHL cable, to the image receiving device, or a notification of an incoming call over video and audio being reproduced which are displayed by the mobile terminal when the mobile terminal receives a call. In FIG. 14, “precedence over call” means that the user is not made aware of receipt of an incoming call to the mobile terminal. More specifically, if “precedence over call” is set (ON is selected), when the mobile terminal receives a call, a ringtone of the mobile terminal is muted or the volume is reduced (the level of the ringtone is decreased). That is, setting of “precedence over call” means muting the ringtone output by the image receiving device or reducing a display size of a message icon (on-screen display [OSD]) displayed by the image receiving device in a display screen in setting an on speaker mode, for example. Further, when “precedence over call” is set, it is possible to make a selection of not displaying the message icon (OSD) in the display screen by the image receiving device (i.e., the user can set the display). The incoming call notification display can be set to be OFF in advance, and in that case, an incoming call notification is not displayed, also. Furthermore, when the mobile terminal receives an incoming call, “call assist” enhances the user's convenience of answering the call. When this is set (ON is selected), a speech output (volume) of the image receiving device is muted or the volume is reduced (the level of the output volume is decreased).

More specifically, when receipt of the incoming call to the mobile terminal is detected [01], it is determined whether “precedence over viewing/listening” is set [02].

When “precedence over call” is set, or when it is selected by user selection[02—ON], speech output (ringtone) of the mobile terminal 200 is turned off [03]. In this case, OSD display for the image receiving device 100 is not performed, as shown in FIG. 10.

Next, it is determined whether or not the incoming call notification display is ON (set), or a user is allowed to select the display [04]. When the incoming call notification display is ON [04—ON], an incoming call notification indicating that an incoming call is received by the mobile terminal 200, and guidance for accepting an operation input (answering selection) of whether to answer the call are displayed on an image displayed by the television device (image receiving device) 100 [05]. In this case, an example of the OSD display in the image receiving device is as shown in FIG. 7 or 8.

When the incoming call notification display is OFF [04—OFF], at that point in time, the user is not aware of the receipt of the incoming call (since the setting causes the incoming call to be neglected). When “precedence over call” is set in advance [02—ON], the subsequent operations can be substantially omitted.

When an operation input of answering selection is performed (answer for incoming call is select) with respect to the incoming call notification display and the guidance display [06—YES], a call is started [07]. Then, with respect to the application of “call assist”, whether or not the user operation has been performed (whether selection is made by the user) is determined [08]. When “call assist” is selected/user operation is performed [08—ON], the speech output of the image receiving device is lowered [09]. Also, when “call assist” is selected, the speech output may be muted [09]. In this case, an example of the operation of the image receiving device is shown in FIG. 9.

When no is selected for “answering selection (answer for incoming call is not select)” [06—NO], the subsequent operations can be substantially omitted. If, when no is selected for “answering selection”, a message such as “I will call back later” or “I cannot take the call now” may be given.

If the call is ended [10—YES]-[11], when the speech output is lowered or muted as a result of the selection of “call assist” [12—NO], the speech output level of the image receiving device is returned to the original level [13]. It should be noted that the call received by the mobile terminal 200 can be displayed so that the finishing of the conversation of the incoming call received by the mobile terminal 200 can be entered only by the operation of the remote controller 163 through an input screen whose OSD display example is shown in FIG. 8.

FIGS. 15A and 15B illustrate an example of setting a notification of an incoming call from the image receiving device 100, which is displaying video, to the mobile terminal 200. The operation that will be described below can be performed at predetermined timing after mutual recognition is finished between the image receiving device 100 connected via the MHL cable 10 and the mobile terminal 200 shown in FIGS. 4 and 5 (and FIG. 1). Settings can be made at arbitrary timing while the image receiving device 100 is activated, by causing the remote controller 163 to select settings (by displaying a setting screen from the main menu), even when video is being displayed or a stream is being received.

When a control input to instruct display of a menu screen is entered from the remote controller 163 to the image receiving device 100 which is reproducing video and audio of a stream transmitted from the mobile terminal 200, a menu screen 511 is displayed at a predetermined position in a screen display 501, which is displaying the video, as shown in FIG. 15A. The menu screen 511 includes a [Settings] bar 521 which allows the user to enter a control input (instruction) on all the settings, for example, an [MHL setting] bar 523 which allows the user to enter a control input on MHL connection, for example, and a [Screen size] bar 525 which allows the user to enter a control input on the display size of the screen, for example.

By focusing on the [MHL setting] bar 523 in the menu screen 511 shown in FIG. 15A (by selecting the [MHL setting] bar by operation of a predetermined key of the remote controller 163 and pressing “Enter” key), for example, an [MHL setting] screen 541 shown in FIG. 15B is displayed.

The [MHL setting] screen 541 shown in FIG. 15B is an item setting screen in a checkbox form or a radio button form, for example, which allows the user to select one of an arbitrary number of setting items. The [MHL setting] screen 541 includes a [notification selection] box 543, which allows the user to select one of “Notify” and “Do not notify” when the mobile terminal (200) receives an incoming call, a [notification method selection] box 545, which allows the user to select one of a plurality of setting items, such as “Notify by stopping replay of video”, “Notify by displaying ‘Incoming call’ message”, and “Notify of ‘Incoming call’ by muting speech (audio) output”, for example, as a method of notification when “Notify” is checked (“Notify” is selected) in the [notification selection] box 543, and the like. When “Do not notify” is selected in the [notification selection] box 543, it is preferable to change the [notification method selection] box 545 to grayed-out display, for example, such that a selection input cannot be made.

The [MHL setting] screen 541 shown in FIG. 15B can be set for each user, i.e., for each mobile terminal 200. That is, by identifying individual mobile terminals 200 on the basis of information unique to the mobile terminal 200 such as a media access control (MAC) addresses, it is possible to specify the user who owns the terminal. Therefore, settings can be made individually for each of a plurality of users. Even when the user owns two or more mobile terminals, settings can be made for each of the mobile terminals.

FIGS. 16A, 16B, 16C, and 16D illustrate an example of setting a notification of an incoming call from the mobile terminal 200 which is transmitting a stream to the image receiving device 100. The operation that will be described below can be performed at predetermined timing after mutual recognition has finished between the image receiving device 100 connected via the MHL cable 10 and the mobile terminal 200 shown in FIGS. 4 and 5 (and FIG. 1). Settings can be made at arbitrary timing in the mobile terminal 200 by selecting a setting (by displaying a setting screen from a menu screen or activating a setting mode) even if video is being displayed or a stream is being received.

A setting screen is displayed or a setting mode is activated in the mobile terminal 200 while a stream is being transmitted to the image receiving device 100 or by selecting a setting (by displaying a setting screen from a menu screen or activating a setting mode) in the mobile terminal 200 (see FIG. 16A).

When an incoming call notification (MHL) is selected in the displayed setting screen or the activated mode setting screen shown in FIG. 16A, modes (types of settings) that allow the user to make settings as to whether to select “precedence over viewing/listening” or “precedence over call”, and whether to display an incoming call notification or not are displayed by an item setting screen in a checkbox form or a radio button form shown in FIG. 16C, for example, which allows the user to select one of an arbitrary number of setting items. When “precedence over viewing/listening” is selected, for example, a detailed setting screen is displayed in a radio button form or a checkbox form, as shown in FIG. 16C, for example. When “video priority” is selected, for example, a detailed setting screen is displayed in a radio button form or a checkbox form, as shown in FIG. 16D, for example.

Thereby, the user is capable of setting an incoming call notification in accordance with the selected (entered) “precedence over viewing/listening” (settings in FIG. 16C) or “precedence over call” (settings in FIG. 16D) shown in FIG. 16B. The setting items include at least items corresponding to the selections (settings) described with reference to FIGS. 10-14, for example, and are completed when “End (Enter)” button is pressed, for example, in each of the setting screens (FIGS. 16C and 16D).

The display format (layout) of the setting screens shown in FIGS. 16A, 16B, 16C, and 16D, the order of display thereof, the shape and the size of the buttons via which an instruction is entered, and the like differ from one mobile terminal to another. Since a plurality of mobile terminals can be identified by the image receiving device 100 on the basis of information unique to the mobile terminal 200, such as a media access control (MAC) addresses, the user who owns a terminal can be specified. Therefore, settings can be made individually for each of a plurality of users. Even when the user owns two or more mobile terminals, it is possible to make settings for each of the mobile terminals.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

That is, according to the embodiment, when a mobile terminal connected to an image receiving device via MHL or wireless communications receives an incoming call, it is possible to notify the user of receipt of the incoming call by displaying the receipt of the incoming call on the side of the image receiving device, without immediately stopping a video/speech signal. That is, since the video/speech output of a stream being reproduced is not suddenly interrupted, user friendliness is improved. The notification of the incoming call may be output to the side of the image receiving device as video/speech generated by the mobile terminal and displayed.

Further, according to an embodiment, since reproduction of a stream, i.e., output of video/speech is continued in each of the mobile terminal and the image receiving device until a call is started, user-friendliness is improved.

Moreover, according to an embodiment, since start of answer to an incoming call can be controlled by the side of the image receiving device via a remote controller (attached to the image receiving device) or the like, a call can be made without the need to hold the mobile terminal in hand. That is, it is possible for the user to make a response to a control input screen displayed on the image receiving device via a remote controller in the image receiving device with respect to start and end of a call made via a mobile terminal communicating with the image receiving device. It is also possible to perform processes of starting and ending a call between a mobile terminal communicating with an image receiving device and a caller of the mobile terminal via the image receiving device by means of speech processing.

Further, according to an embodiment, when a mobile terminal receives an incoming call, it is possible to stop speech from a device different from a device with priority according to whether “precedence over call”, which gives priority to reproduction of video and speech (audio) of a stream reproduced by the image receiving device, or “precedence over viewing/listening”, which gives priority to answer to a call from the mobile terminal is set.

Moreover, according to an embodiment, when output of a video/speech signal of the mobile terminal is interrupted by start of a call, it is possible to automatically restart output of the video/speech signal when the call has ended. Reproduction of a stream interrupted (temporarily suspended) by start of a call can be automatically returned to the state immediately before the start of the call by resuming when the conversation has ended.

Moreover, according to an embodiment, when speech of the image receiving device is muted by start of a call, the speech output can be automatically returned to the original level step by step or immediately when the conversation has ended, and hence user-friendliness is not reduced.

That is, even when an incoming call is received while the image receiving device is reproducing a video/speech signal from the mobile terminal, since the video/speech output is not suddenly stopped, and the user is notified of the receipt of the incoming call through the screen of the image receiving device, it is possible for the user to enjoy viewing and listening to the reproduction video and speech (audio) of a stream reproduced by the image receiving device. Further, by setting “video priority”, it is possible for the user to enjoy the video and speech supplied by the mobile terminal in the image receiving device without interruption by an incoming call. By setting “call priority”, on the other hand, it is possible for the user to start a call without the need to move to the side of the mobile terminal when an incoming call is received.

What is claimed is:

1. An electronic device comprising:
a display configured to display video;
a speech reproduction module configured to reproduce speech;
a reception module configured to receive a notification of an incoming call to a connected call-capable device; and
a controller configured to cause the display to display receipt of the incoming call when the reception module receives the notification of the incoming call to the call-capable device.

2. The electronic device of claim 1, wherein the controller configured to reduce a reproduction level of the speech reproduction module following or in parallel to the process of displaying receipt of the incoming call.

3. The electronic device of claim 1, further comprising:
a remote control reception module configured to receive a control input from the controller made in response to the display of the receipt of the incoming call displayed by the display.

4. The electronic device of claim 3, wherein the controller configured to reduce a reproduction level of the speech reproduction module at predetermined timing after a control input made in response to the display of the receipt of the incoming call is received.

5. The electronic device of claim 1, further comprising:
a speech processing module configured to receive speech made in response to the incoming call and make the call via a communication module of the connected call-capable device.

6. The electronic device of claim 3, further comprising:
a speech processing module configured to receive speech made in response to the incoming call and make the call via the communication module of the connected call-capable device.

7. An electronic device comprising:
a display configured to display video;
a speech reproduction module configured to reproduce speech;
a transmitter configured to transmit a stream to a connected electronic device and make a notification of an incoming call; and
a controller configured to control the transmission of the stream on the basis of a response from the electronic device to the incoming call of which the transmitter has made the notification to the electronic device.

8. The electronic device of claim 7, wherein the controller temporarily suspends the transmission of the stream when the response from the electronic device to the incoming call of which the transmitter has made the notification is start of a conversation.

9. The electronic device of claim 7, wherein the controller reduces the speech reproduction level of the stream when the response from the electronic device to the incoming call of which the transmitter has made the notification is start of a conversation.

10. A method for controlling an electronic device comprising:
receiving an incoming call to a connected call-capable device; and
outputting a signal making a notification of receipt of the incoming call to the connected call-capable device to a video signal and/or a speech signal of a stream being reproduced.

11. The method for controlling the electronic device of claim 10, wherein a speech reproduction level is reduced at predetermined timing after a control input made in response to a display of the receipt of the incoming call is received.
